(19) United States
(12) Patent Application Publication
(10) Pub. No.: US 2012/0006779 A1
(43) Pub. Date: Jan. 12, 2012

(54) CONTAINER CRANE

(75) Inventors: Robert Arthur Mills, Lancashire (GB); ZhanMin Tong, Singapore (SG); Ghee Hua Ng, Singapore (SG)

(73) Assignee: NLS Engineering Pte Ltd, Singapore (SG)

(21) Appl. No.: 13/260,241

(22) PCT Filed: Mar. 19, 2010
(86) PCT No.: PCT/SG2010/000105

§ 371 Date: Sep. 23, 2011

(30) Foreign Application Priority Data
Mar. 24, 2009 (SG) 200902082-7

(51) Int. Cl. B66C 19/00; B66C 13/00

(52) U.S. Cl. 212/71; 212/270

(57) ABSTRACT

The invention provides a container crane comprising a frame having a trolley rail along which a trolley travels; said trolley supporting a twin spreader assembly for engaging one or more containers, and; a docking station mounted to said frame; wherein said trolley is arranged to move said twin spreader assembly to the docking station and be placed therein.

### FIELD OF THE INVENTION

The invention relates to container cranes for the loading and unloading of shipping containers, such as quayside cranes. In particular, the invention relates to the use of twin spreaders on a container crane.

### BACKGROUND

The use of twin spreaders is becoming more prevalent so as to increase the rate of movement of shipping containers for loading and unloading. As it is also documented whilst twin spreaders are useful for maximizing capacity, they are not applicable in all instances and so it is important to be able to switch between single and twin spreaders when applicable. Such switching is disclosed in PCT application no. PCT/SG2006/000015 the contents of which are incorporated herein.

In this document, a flexible arrangement which allows for a twin spreader to be used and then de-coupled to allow for single spreader use in detailed. What is not disclosed is the most efficient way of dealing with the separation of these spreaders and the method of storing said spreaders when not in use.

A spreader for a 40-foot container and even one extendable for use with a 20-foot container and 40-foot container represents an extremely large piece of equipment which is not easily stored. In a container yard with storage space represents potential opportunities for revenue storing a large piece of equipment like a spreader represents a loss of potential income not to mention logistical issues of being able to provide excess by trucks to a quay crane. Where storage space for equipment is often in non-productive area of a container yard this makes the availability of a spreader to reconnect to form a twin spreader inefficient and a significant detriment from the benefits a twin spreader can provide.

### SUMMARY OF INVENTION

In a first aspect, the invention provides a container crane comprising a frame having a trolley rail along which a trolley travels; said trolley supporting a twin spreader assembly for engaging one or more containers, and; a docking station mounted to said frame; wherein said trolley is arranged to move said twin spreader assembly to the docking station and be placed therein.

In a second aspect, the invention provides a method of operating a container crane, the method comprising the steps of: providing a frame having a rail along which a trolley travels, said trolley supporting a twin spreader assembly for engaging one or more containers; providing a docking station mounted to said frame; moving the trolley along the rail so as to be proximate with the docking station, and; positioning the twin spreader assembly into the docking station.

Thus a complete solution provided by a combination of a container crane and a docking station mounted directly thereto allows for the twin spreader to access the docking station. It may further allow for the twin spreader to de-couple one spreader for use as a single spreader. The de-coupled spreader may then reside in the docking station in storage until needed again.

The container crane, and in particular the rail upon which the trolley moves, may have an operational zone within which the trolley operates to engage containers and a maintenance zone for maintenance to the trolley and twin spreader assembly.

In this embodiment, in the docking station is mounted to the frame proximate to the maintenance zone of said rail. This way, the spreader assembly may undergo maintenance and other activity, in the same way the trolley undergoes maintenance.

In light of this, it may be advantageous to have the docking station mounted proximate to a maintenance platform of said crane

In a further embodiment, it may be beneficial to have the docking station move into the operational zone. To this end, the docking station may be movably mounted to the frame such that the docking station is selectively movable from the a position proximate to the maintenance zone to a position proximate to the operational zone

### BRIEF DESCRIPTION OF DRAWINGS

FIGS. 1A and 1B are elevation views of a container crane system according to one embodiment of the present invention;

FIGS. 2A and 2B are elevation views of the container crane system according to FIGS. 1A and 1B;

FIGS. 3A and 3B are elevation views of the container crane system according to FIGS. 1A and 1B;

FIGS. 4A and 4B are elevation views of the container crane system according to FIGS. 1A and 1B;

FIGS. 5A and 5B are elevation views of the container crane system according to FIGS. 1A and 1B;

FIGS. 6A and 6B are elevation views of the container crane system according to FIGS. 1A and 1B;

FIGS. 7A and 7B are elevation views of a container crane system according to a further embodiment of the present invention;

FIGS. 8A and 8B are elevation views of the container crane system according to FIGS. 7A and 7B;

FIGS. 9A and 9B are elevation views of the container crane system according to FIGS. 7A and 7B;

FIGS. 10A and 10B are elevation views of the container crane system according to FIGS. 7A and 7B;

FIGS. 11A and 11B are elevation views of the container crane system according to FIGS. 7A and 7B;

FIGS. 12A and 12B are elevation views of the container crane system according to FIGS. 7A and 7B;

FIGS. 13A and 13B are elevation views of the container crane system according to FIGS. 7A and 7B, and;

FIGS. 14A and 14B are elevation views of the container crane system according to FIGS. 7A and 7B.

### DETAILED DESCRIPTION

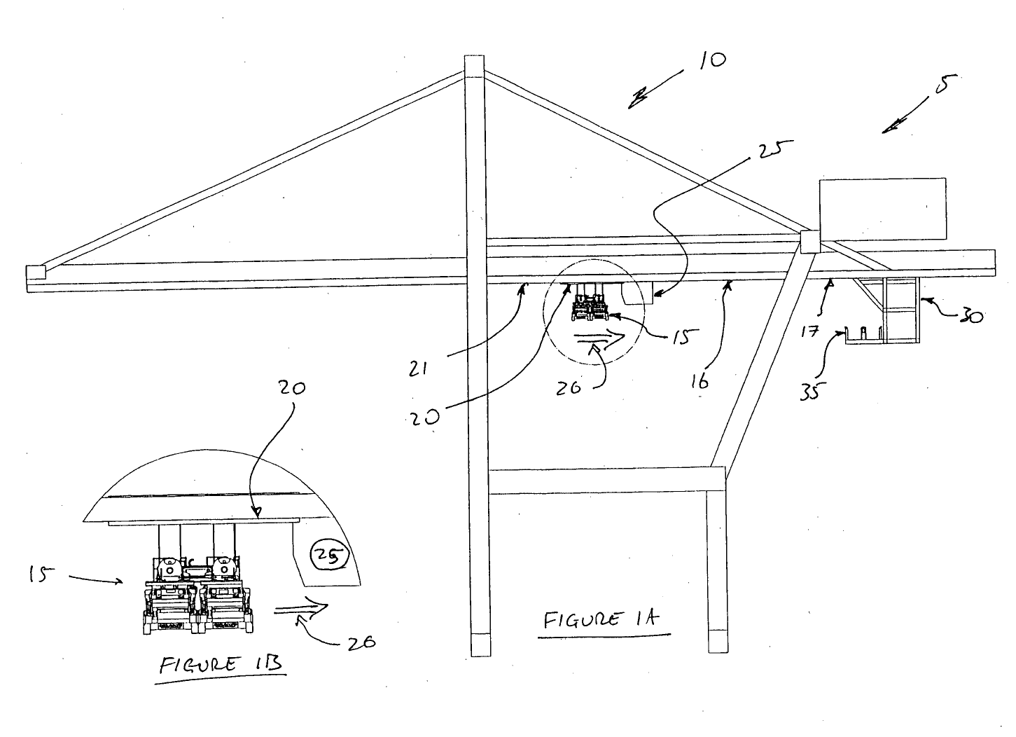

FIGS. 1A and 1B show a container crane, in this case a quayside crane 5 comprising a frame 10 having a twin spreader arrangement 15 supported upon a trolley 20. The crane operator is located within a cabin 25 which is linked to the trolley 20 and travels 26 along a rail 21 as a single unit. The rail has two zones being an operational zone 16 where the trolley normally operates during the movement of containers, and a maintenance zone 17, where the trolley is moved so as to undergo maintenance. Mounted proximate to the maintenance zone 17 of the rail 21 of the quayside crane is a docking station 35 mounted to the frame 10 using a docking structure 30.

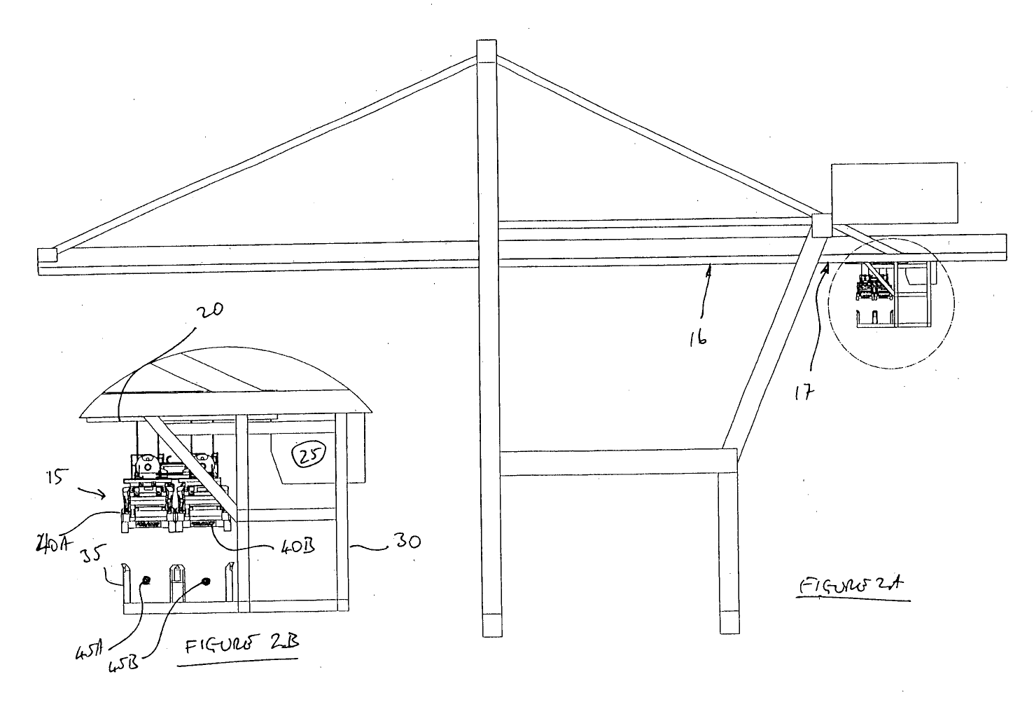

FIGS. 2A and 2B show the first step of the coupling a twin spreader arrangement 15 whereby the trolley 20 has moved to the maintenance zone 17 of the rail 21 so as to bring the twin spreader 15 proximate to the docking structure 30.

The twin spreader assembly 15 includes individual spreaders 40A, 40B which in this case involves a master spreader 40A and a slave spreader 40B. The two spreaders are so designated because the control systems for connection and manipulation are generally located on the master spreader 40A with the slave spreader 40B following the control on the master spreader.

As shown in FIGS. 2A and 2B, the respective spreaders 40A, 40B are positioned above the docking station 35 and in particular the spreaders located above respective slots 45A, 45B within the docking station 35.

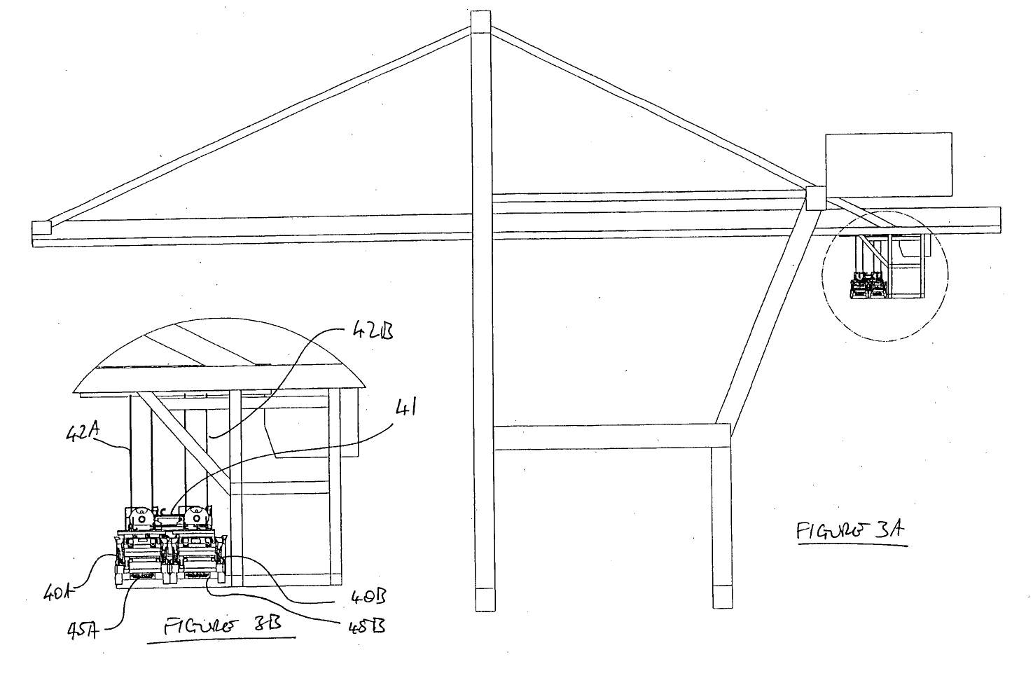

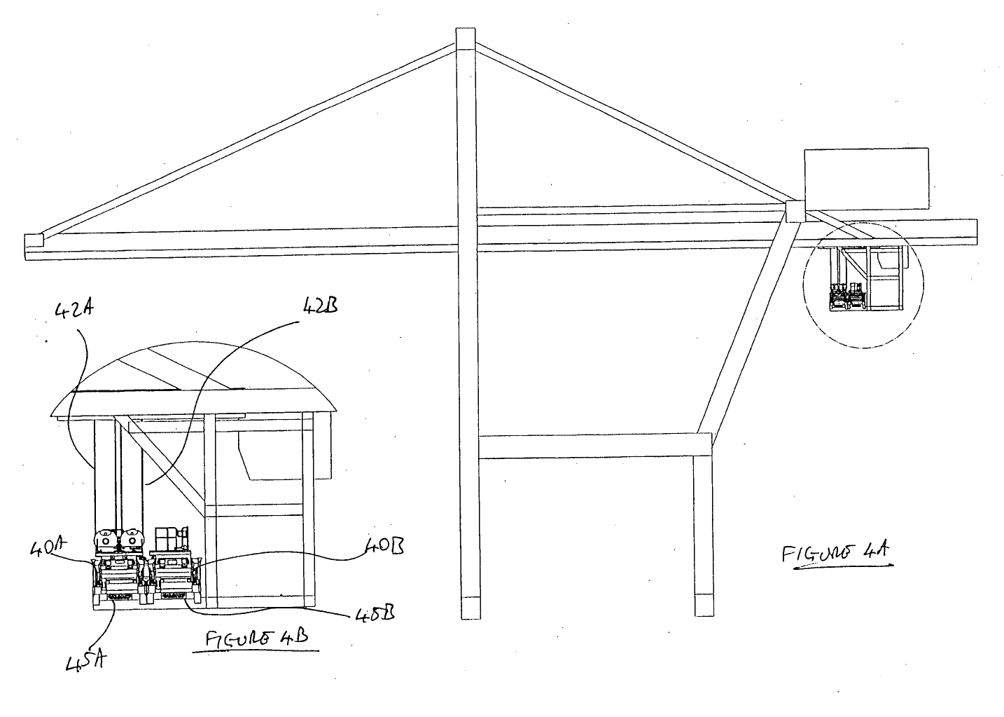

FIGS. 3A and 3B show the placement of the spreaders 40A, 40B into the respective slots 45A and 45B. In this position, the de-coupling procedure can begin. FIGS. 4A and 4B show the retraction of the connecting arm 41, which slides the sheaves and cables 42B from the slave spreader 40B onto the headblock of the master spreader 40A. This leaves the slave spreader 40B unattached with the master spreader forming a single spreader arrangement.

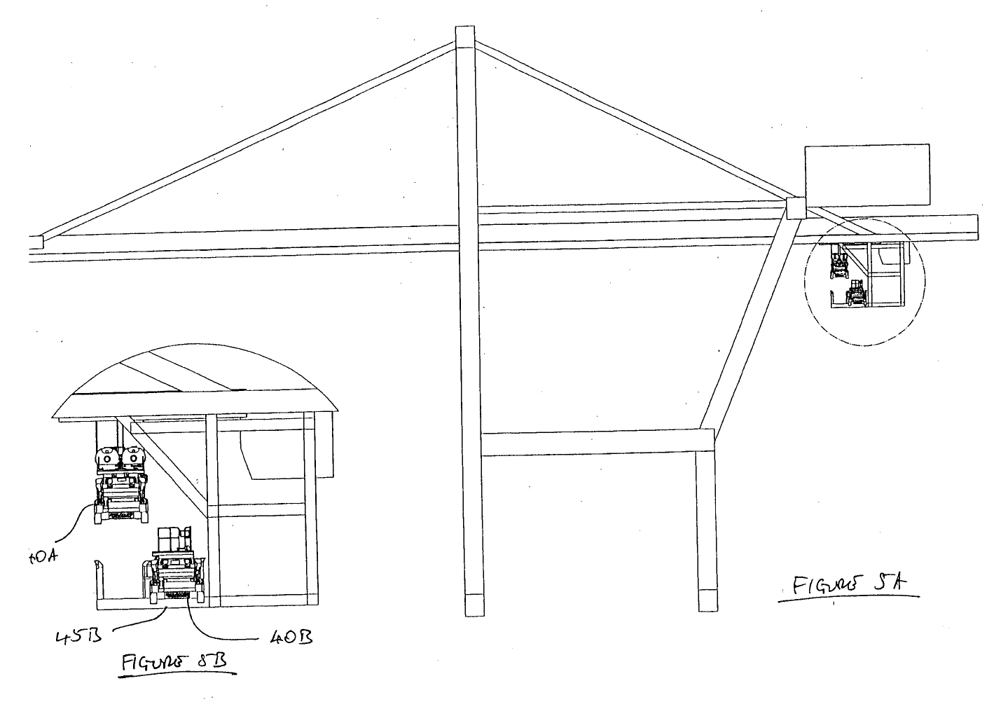

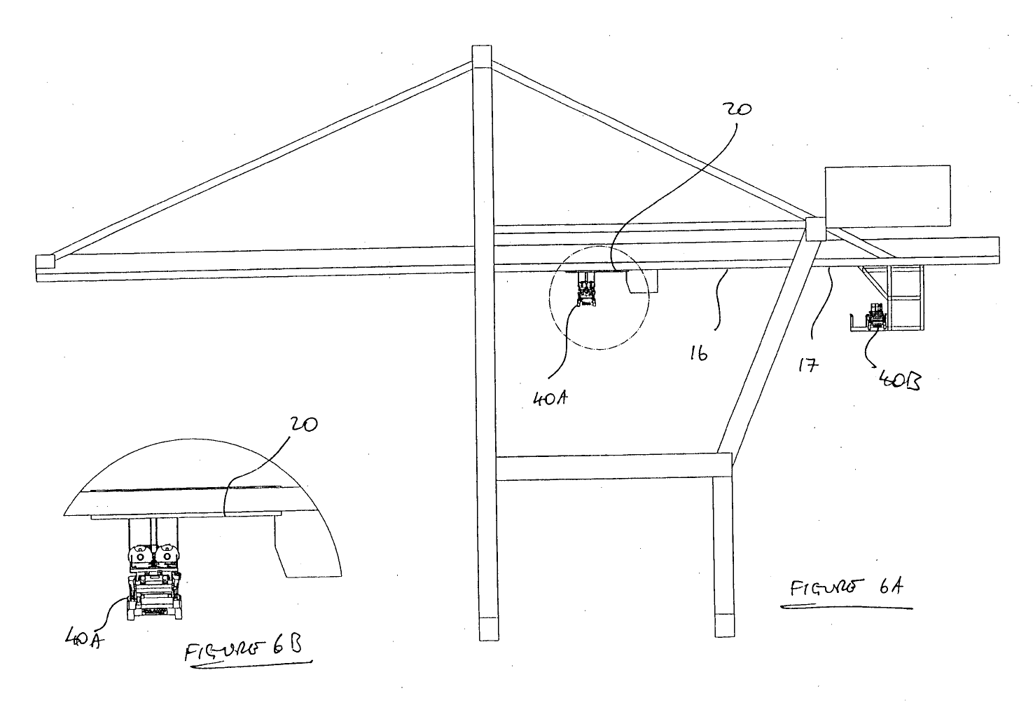

FIGS. 5A, 5B, 6A and 6B show the removal of the single spreader 40A from the docking station and its movement from the maintenance zone 17 to the operational zone 16. The de-coupled slave spreader 40B can now be stored within the docking station and the master spreader removed and brought into action such that the quayside crane now operates in a single spreader mode.

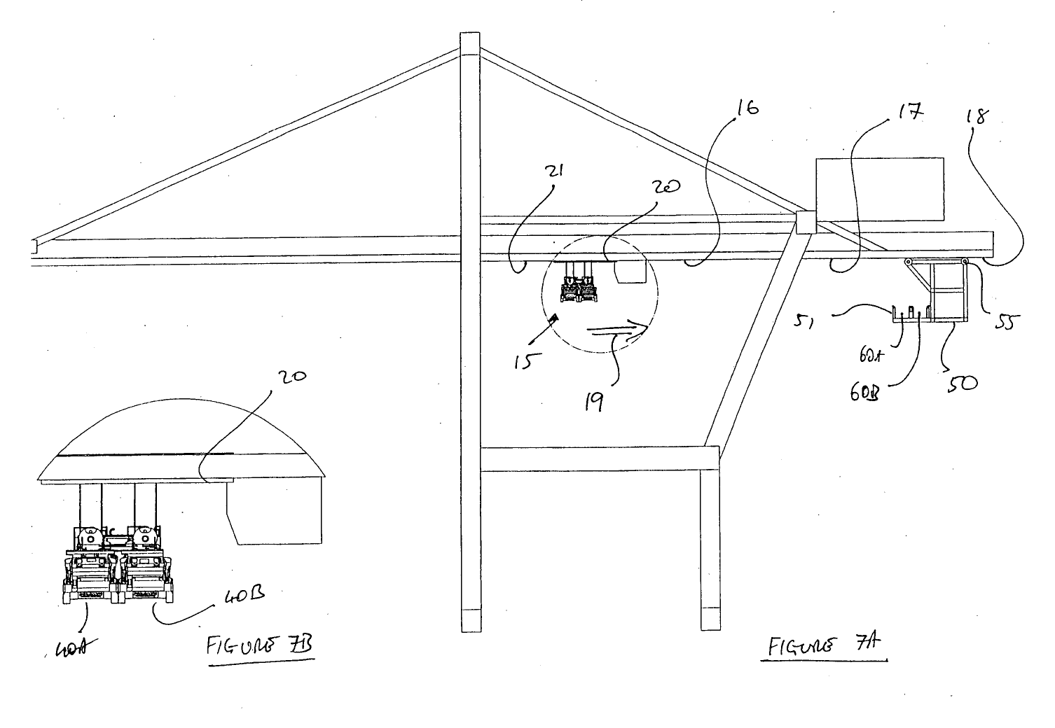

FIGS. 7A and 7B show an alternative arrangement of the docking structure 50 whereby the structure 50 is located upon a rail system 55, such that the docking station 51 is now movably mounted to the frame 10. To further enhance the efficiency of the system, the docking structure 50, and so the docking station 51, maybe moveable upon a dedicated rail 55 so as to bring the docking station within the normal operating range of the quay crane rail 21.

In one embodiment, when only one spreader is required, rather than the operator moving the trolley 20 out of the operational zone 16 of the rail 21, the docking structure 50 can be moved closer and be available to the operator whilst still within a normal operating range.

In this embodiment, however, the spreader arrangement is moved 19 from the operational zone 16 into the maintenance zone 17. The docking structure 50 is positioned in a resting zone 18 at the far end of the rail.

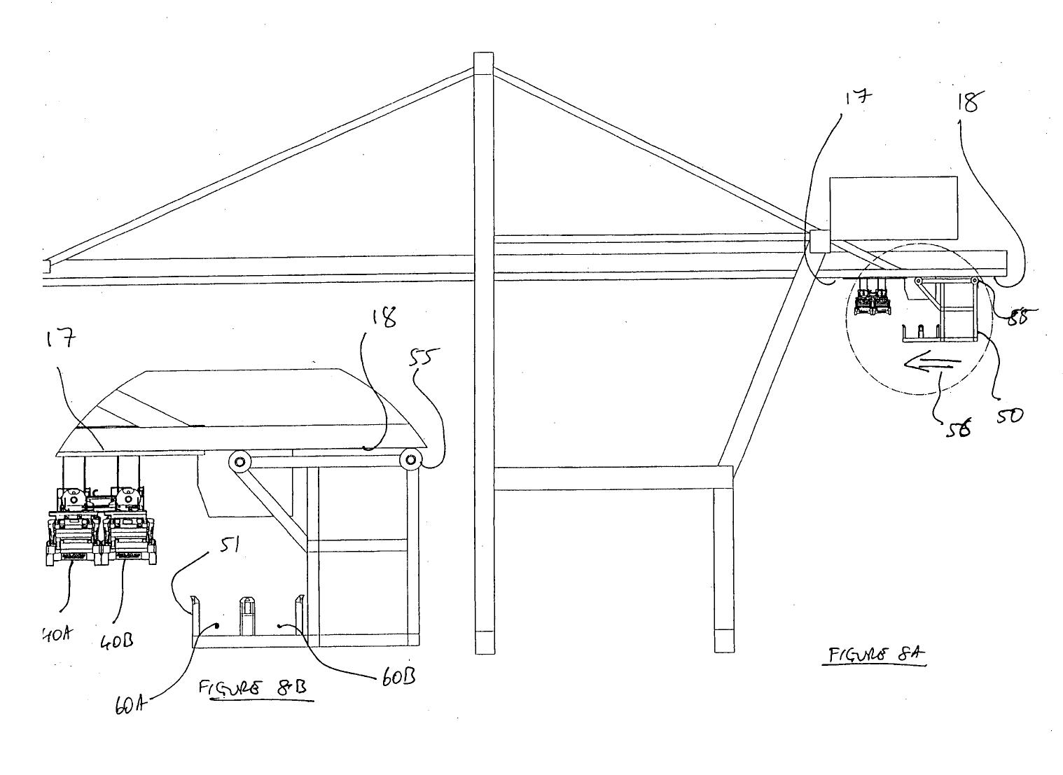

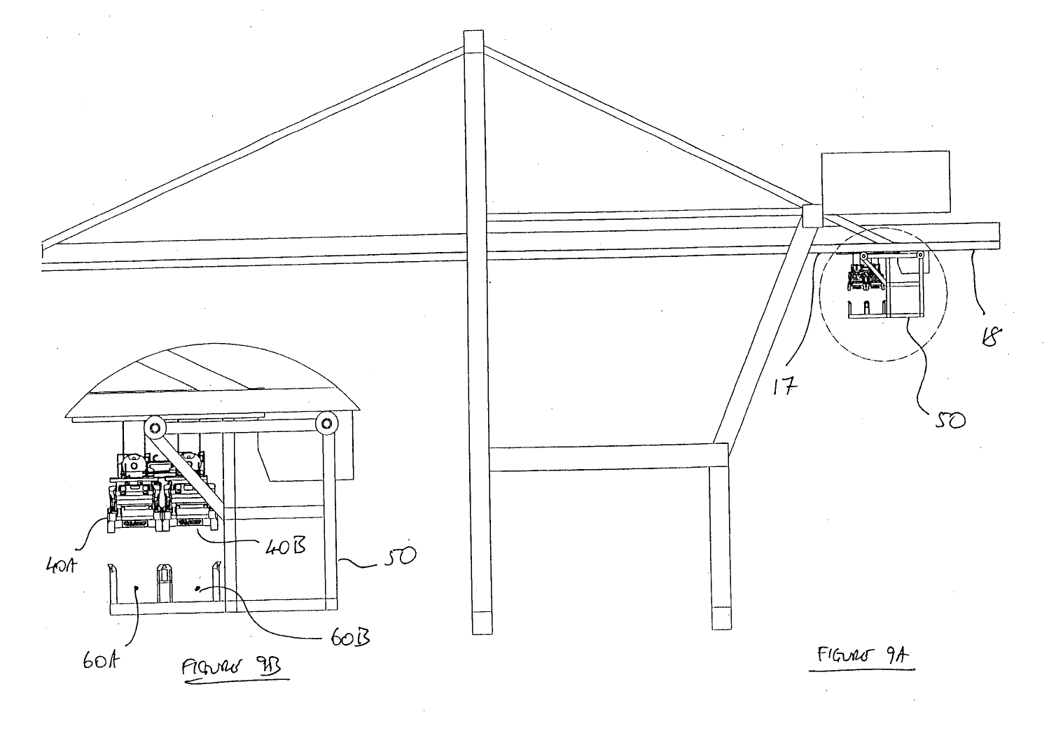

As shown in FIGS. 8A and 8B the docking structure may be brought into the maintenance zone 17 from the resting zone 18. The docking structure 50 moves 56 into position, with FIGS. 9A and 9B showing the final position of the docking structure 50 such that the individual spreaders 40A, 40B are positioned above the respective slots 60A, 60B.

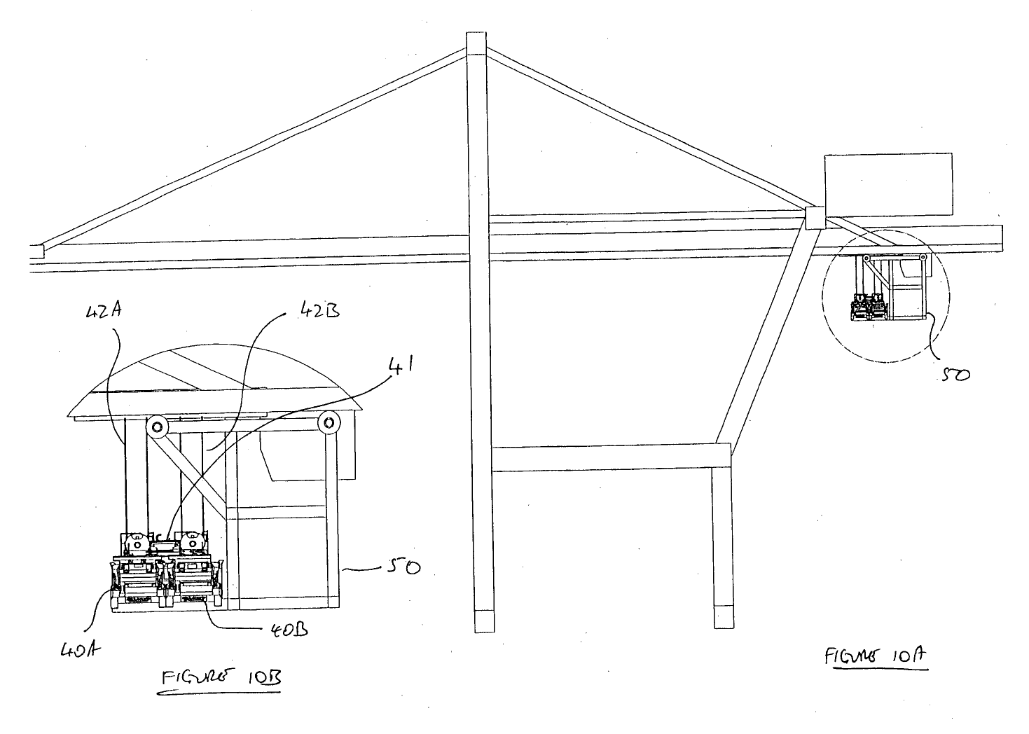

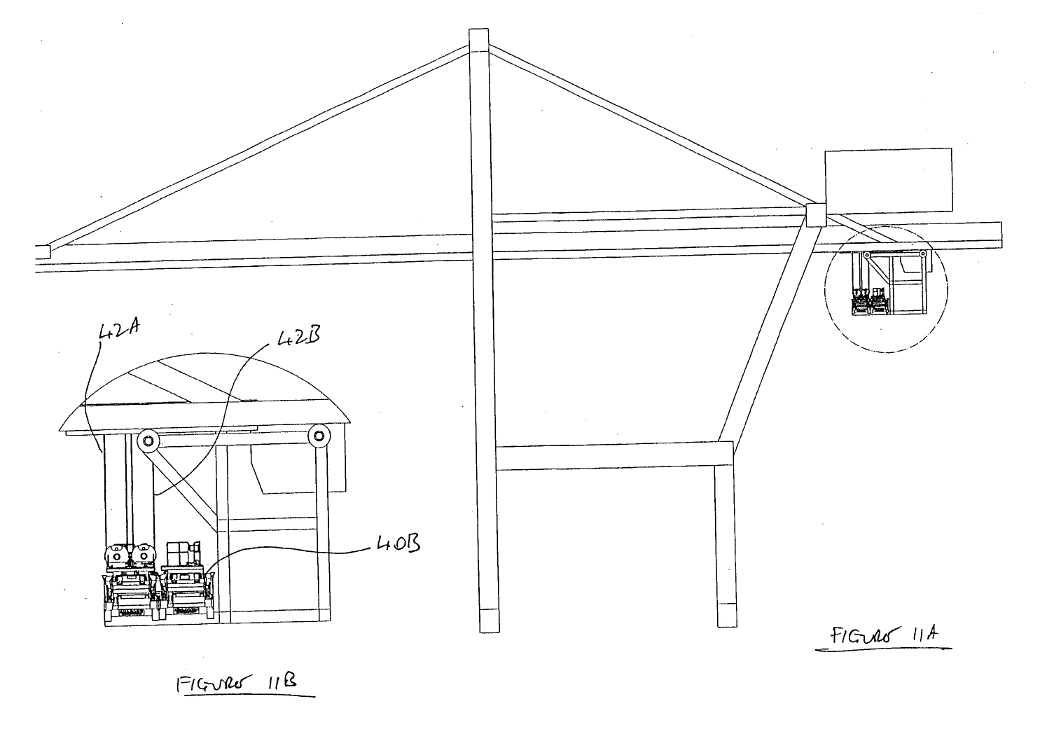

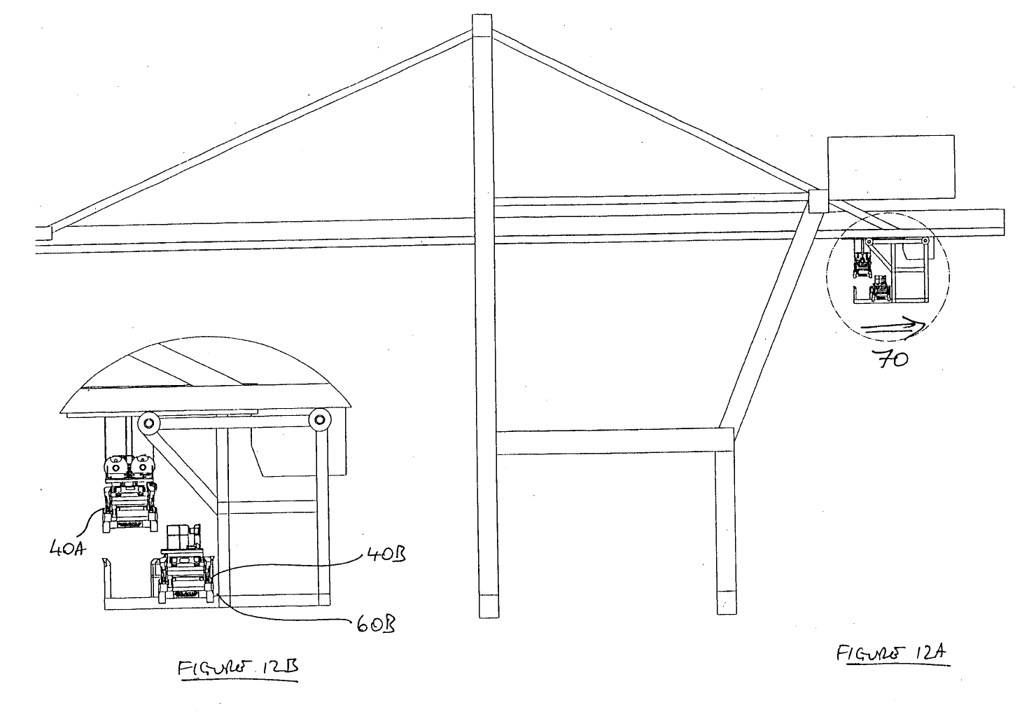

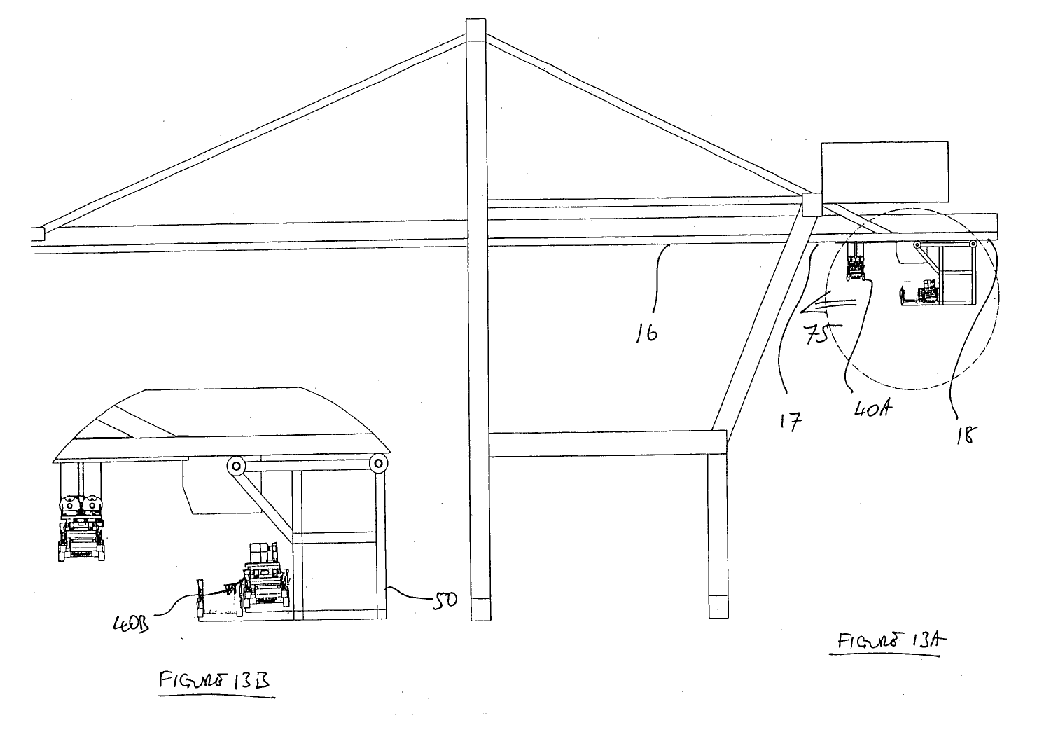

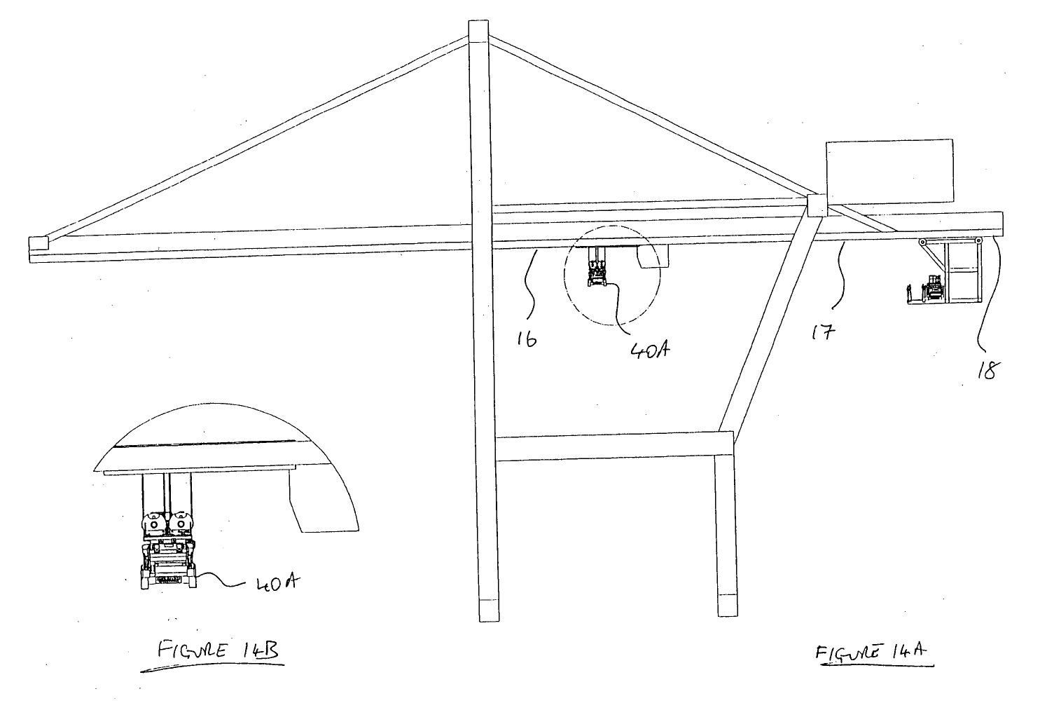

FIGS. 10A and 10B show the final position of the twin spreader, similar to that shown in FIGS. 3A and 3B whereby the de-coupling procedure can begin. FIGS. 11 to 14 show the completion of de-coupling, and the removal of the master spreader back into the operational zone 16 ready for single spreader use.

The docking structure 50 is then moved 70 back to its original position in the resting zone 18, outside the normal operating range of the trolley taking the slave spreader 60B with it, until a twin spreader arrangement is required, or if the master spreader needs to be stored or undergo maintenance. Under each of these scenarios, the docking structure can then be returned to the maintenance zone 17 for the appropriate action.

1. A container crane comprising:
a frame having a trolley rail along which a trolley travels, said trolley supporting a twin spreader assembly for engaging one or more containers; and
a docking station mounted to said frame, wherein said trolley is arranged to move said twin spreader assembly to the docking station and be placed therein.

2. The container crane according to claim 1, wherein said twin spreader assembly is capable of de-coupling one of said spreaders whilst within said docking station.

3. The container crane according to claim 1, wherein said docking station arranged to store the de-coupled spreader.

4. The container crane according to claim 1, wherein said crane is a quayside crane.

5. The container crane according to claim 1, wherein the rail includes an operational zone within which the trolley operates to engage containers and a maintenance zone for maintenance to the trolley and/or twin spreader assembly.

6. The container crane according to claim 5, wherein the docking station is mounted to the frame proximate to the maintenance zone of said rail.

7. The container crane according to claim 6, wherein said docking station is mounted proximate to a maintenance platform of said crane.

8. The container crane according to claim 5, wherein the docking station is movably mounted to the frame such that the docking station is selectively movable from the a position proximate to the maintenance zone to a position proximate to the operational zone.

9. A method of operating a container crane, the method comprising the steps of:
providing a frame having a rail along which a trolley travels, said trolley supporting a twin spreader assembly for engaging one or more containers;
providing a docking station mounted to said frame;
moving the trolley along the rail so as to be proximate with the docking station; and
positioning the twin spreader assembly into the docking station.

10. The method according to claim 9, further including the steps of:
de-coupling a spreader from the twin spreader assembly, so as to have a single spreader supported by the trolley; and
removing the single spreader from the docking station so as to have the de-coupled spreader residing in the docking station.
